(19) United States
(12) Patent Application Publication
(10) Pub. No.: US 2016/0280475 A1
(43) Pub. Date: Sep. 29, 2016

(54) METHOD AND APPARATUS FOR HANDLING ARTICLES, PIECE GOODS, OR BUNDLES, RESPECTIVELY

(71) Applicant: KRONES Aktiengesellschaft, Neutraubling (DE)

(72) Inventors: Manuel KOLLMUSS, Raubling (DE); Richard ESCHLBECK, Vogtareuth (DE); Hubert RUEEGG, Emmering (DE)

(21) Appl. No.: 15/076,726

(22) Filed: Mar. 22, 2016

(30) Foreign Application Priority Data
Mar. 23, 2015 (DE) 102015104324.6

(51) Int. Cl. B65G 57/11; B65G 57/03

(52) U.S. Cl. CPC B65G 57/11; B65G 57/03

(57) ABSTRACT

Disclosed is a method for conveying, handling, manipulating, stacking, and/or palletizing articles (20), piece goods, and/or bundles, which are fed in conveying direction (38) to a handling station and/or grouping station (52) and are taken up there within a defined manipulating section (50) by means of a handling device and/or manipulating device (34), are rotated and/or shifted and thus respectively brought into an arrangement (46) to each other so as to be stackable or palletizable. The arrangements (46) are subsequently stacked on top of one another and/or palletized for the purpose of forming stacked layers (60) of articles, piece goods, and/or bundles. The articles (20), piece goods, and/or bundles are transferred to the handling station and/or grouping station (52) as pairs or triplets (14), which have been stacked pairwise or triple-wise on top of one another in a stacking station 64 arranged upstream.

Moreover disclosed is a corresponding arrangement of stations (12) for conveying, handling, and/or palletizing, which are arranged consecutively in conveying direction (38), for the purpose of conveying, handling, manipulating, stacking, and/or palletizing articles (20), piece goods, and/or bundles. A handling station and/or grouping station (52) comprises a handling device and/or manipulating device (34) for taking up, rotating, and/or shifting the articles (20), piece goods, and/or bundles within a defined manipulating section (50). Arranged downstream in conveying direction (38) from the handling station and/or grouping station (52) is a palletizing station (54) for the purpose of stacking and/or palletizing stackable or palletizable arrangements (46) of articles, piece goods, and/or bundles. In addition, a stacking station (64) is arranged upstream in conveying direction (38) from the handling station and/or grouping station (52) for the purpose of pairwise or triple-wise stacking on top of one another articles (20), piece goods, and/or bundles before they are transferred to the handling station and/or grouping station (52).

The present invention relates to a method as well as to an apparatus with the features of the independent claim 1 or 5, respectively, for conveying, handling, manipulating, stacking, and/or palletizing articles, piece goods, and/or bundles, which have been stacked pairwise or in multiples on top of each other.

Known packaging facilities or palletizing facilities for stacking and palletizing objects, such as packages or bundles of several articles, such as, for example, beverage containers, commonly have horizontal conveying devices with conveyor belts on which the piece goods or bundles are conveyed in uninterrupted or irregular sequence to a handling device. There, the individual piece goods or bundles are shifted, aligned, and/or rotated in order to bring them into a suitable spatial arrangement, which forms a basis for pushing together the piece goods or bundles to form stackable layers of piece goods or bundles in grouping stations arranged downstream.

Different methods for rotating the bundles are used in current filling and packaging lines, which can have suitable movable stops or two conveyor belts moving at different speeds, for example. Known handling devices can also have grippers, which are mounted at a gantry system, for example, and which can be shifted, rotated, and additionally be moved in a vertical direction within a defined range of movement in order to be able to lift up individual piece goods or bundles for the purpose of rotating and/or shifting them. The grippers can also be arranged at the arms of multi-axis robots, for example, which are placed laterally at the horizontal conveying devices.

For the purpose of relocating and/or aligning piece goods or bundles when handling them in practice in such a way, they are seized, lifted up, and transferred to a desired position or alignment, respectively, within a group. Numerous gripping apparatuses are already known from the prior art for this purpose, such as, for instance, from EP 2 388 216 A1. This known gripping apparatus has two gripping arms, which are horizontally spaced apart from each other and arranged via mechanical connections at an intermediately arranged carrier. The gripping arms can be moved toward each other in order to seize objects. Under a defined application of force, the gripping arms are furthermore detachable from the carrier in a vertical direction and away from the carrier. At the free ends, both gripping arms have clamping jaws, which are in surface contact with the objects when seizing the respective objects.

A further gripping apparatus is shown in DE 102 04 513 A1, for example. Here, a plurality of oppositely located gripping arms is guided within a middle part. One gripping arm is shiftable in relation to another gripping arm by means of a positioning member such that both gripping arms can be closed. Provided at the lower ends of the gripping arms at the sides facing toward each other are gripping sections for gripping building material packages.

In the known conveying and handling facilities, the bundles are transported individually one after the other. Although several bundles are often simultaneously positioned in the subsequent forming of groups and layers, this is only possible for bundles that are arranged respectively one after the other. Thus, only one layer of bundles is formed during each process of producing a palletizable layer. In order to increase the bundle throughput and palletizing speed of such facilities, the grouping system can stack individual or multiple bundles on top of one another in a first work step and then position them in a second work step.

From U.S. Pat. No. 5,469,687 A, a facility for handling and conveying bundles is known, in which the bundles, each consisting of six assembled beverage cans, are stacked pairwise on top of one another in the course of their conveying path in order to be subsequently fed to a packaging station.

The primary object of the present invention lies in accelerating the processing steps involved in conveying, handling, manipulating, and subsequently palletizing articles, piece goods, and/or bundles, and in providing a correspondingly modified and improved system for handling articles, bundles, groups, or piece goods, which system enables an accelerated throughput, together with a simple controllability, for the articles, piece goods, and/or bundles to be palletized and/or stacked.

This objective of the invention is achieved by the subject matter of the independent claims. Features of advantageous developments of the invention are indicated in the respective dependent claims. In order to achieve the stated object, the present invention thus proposes a method for conveying, handling, manipulating, stacking, and/or palletizing articles, piece goods, and/or bundles, in which method the articles, piece goods, and/or bundles are fed in conveying direction to a handling station and/or grouping station and are taken up there within a defined manipulating section by means of a handling device and/or manipulating device, are rotated and/or shifted and thus respectively brought into an arrangement to each other so as to be stackable or palletizable. The arrangements, which are staged one after another in this manner, can subsequently be stacked on top of one another and/or palletized for the purpose of forming stacked layers of articles, piece goods, and/or bundles. Prior to that in the method according to the invention, however, the articles, piece goods, and/or bundles are transferred to the handling station and/or grouping station as pairwise or triple-wise stacked pairs or triplets, thus making it possible to nearly double the handling throughput in a given period of time, and therewith also the stacking throughput or palletizing throughput, respectively, provided that the feeder devices for staging the articles, piece goods, or bundles individually one after the other can be accelerated to a corresponding extent. Ideally, doubling of the throughput can already be achieved by forming the individual pairs with articles, piece goods, and/or bundles that are stacked respectively pairwise on top of one another and supplied to the handling device and/or manipulating device so that it can rotate, shift, etc. them. As a result, palletizing these pairs of articles, piece goods, and/or bundles that have been pushed together and/or rotated to double layers is also carried out in approximately half the time.

Stacking the bundles, piece goods, or articles is already carried out during the bundle transport by means of stacking modules, optionally also by means of a plurality of series-arranged stacking modules. In the best case, these stacking modules are arranged immediately before the grouping in order to keep the subsequent transport of the stacked bundles as short and as process-reliable as possible in this way. By spreading out the process steps involved in—stacking and grouping—in this manner, substantially increased cycle times and thus also considerably reduced grouping times are possible. As mentioned, the stacked groups of articles, piece goods, and/or bundles, which are transferred to the handling station and/or grouping station, can preferably be double- or triple-stacked on top of one another in a stacking section, which is arranged upstream, in particular, spatially immediately upstream in conveying direction, from the handling station and/or grouping station.

Suitable for carrying out the method according to the invention are so-called conveyor track switches, for example, by means of which the stacked groups of articles, piece goods, and/or bundles can be stacked before they can be subsequently rotated, shifted, or transferred as stacked groups of articles, piece goods, or bundles. These conveyor track switches, which are to be understood as optional features, make it possible to release individual articles, piece goods, and/or bundles at respectively different heights and thus stack them on top of one another. In an alternative variant of the method, the stacked groups of articles, piece goods, and/or bundles can also be stacked by means of separate gripping devices arranged upstream from the handling station and/or grouping station, which gripping devices take up individual articles, piece goods, and/or bundles from the horizontal conveying devices or feeder devices and place them on top of respectively other articles, piece goods, and/or bundles and thus stack them on top of one another.

It can also be an advantage if the handling device and/or manipulating device of the handling station and/or grouping station can seize the groups of articles, piece goods, and/or bundles, which are stacked pairwise or triple-wise on top of one another, at variably adjustable heights for the purpose of taking up, rotating, and/or shifting them within the manipulating section, since in this way it is possible to also reliably seize groups of bundles or piece goods that have irregular side edges and, in particular, different outer circumferences at different heights.

Optionally, the method can additionally provide that the handling device and/or manipulating device of the handling station and/or grouping station removes individual articles of groups of articles, piece goods, and/or bundles, which are stacked pairwise on top of one another, from the article, piece good, or bundle located respectively beneath, or that it removes article pairs of groups of articles, piece goods, and/or bundles, which are stacked triple-wise on top of one another, from the article pair, piece good pair, or bundle pair located respectively beneath, and that it places them in a different location within the manipulating section and/or transfers them to the handling station and/or grouping station. It can additionally be an advantage if the method provides that the handling device and/or manipulating device takes over the article, piece good, or bundle, or takes over the article pair, piece good pair, or bundle pair, respectively, remaining beneath the removed article, piece good, or bundle and transfers it to the handling station and/or grouping station in a subsequent handling step.

For achieving the mentioned object, the present invention furthermore proposes an arrangement of stations for conveying, handling, and/or palletizing, which stations are arranged consecutively in conveying direction, for the purpose of conveying, handling, manipulating, stacking, and/or palletizing articles, piece goods, and/or bundles. This arrangement according to the invention comprises at least one handling station and/or grouping station, which has a handling device and/or manipulating device for taking up, rotating, and/or shifting the articles, piece goods, and/or bundles within a defined manipulating section. The arrangement furthermore comprises a palletizing station arranged downstream in conveying direction from the handling station and/or grouping station for the purpose of stacking and/or palletizing stackable or palletizable articles, piece goods, and/or bundles. In addition, the arrangement according to the invention provides a stacking station arranged upstream in conveying direction from the handling station and/or grouping station for the purpose of pairwise or triple-wise stacking on top of one another articles, piece goods, and/or bundles before they are transferred to the handling station and/or grouping station. Preferably, the stacking station in this instance is arranged upstream, in particular, spatially immediately upstream in conveying direction, from the handling station and/or grouping station. The stacking station can be combined with the handling station and/or grouping station, for example, in an integrated design or in a so-called block design.

The stacking station can optionally comprise conveying devices with conveyor track switches for transferring individual articles, piece goods, and/or bundles at respectively different heights and for stacking them on top of one another. Optionally, the stacking station can also comprise separate gripping devices for taking up individual articles, piece goods, and/or bundles from horizontal conveying devices or feeder devices and for placing them on respectively other articles, piece goods, and/or bundles.

A further embodiment variant of the arrangement according to the invention can provide that a handling device and/or manipulating device of the handling station and/or grouping station comprises a shiftable, rotatable, and/or liftable and lowerable gripping unit with gripping jaws or gripping bars, which are advanceable toward each other, for seizing and manipulating the groups of articles, piece goods, and/or bundles, which are stacked pairwise or triple-wise on top of one another, for the purpose of taking up, rotating, and/or shifting them within the manipulating section. In this context, it can be in particular provided that the gripping jaws or gripping bars of the gripping unit, which are advanceable toward each other, are respectively variably adaptable to different contours of the lateral surfaces of the groups of articles, piece goods, and/or bundles to be seized. Such an adaptable gripper serves for securely seizing the double or triple stacks, in particular if these have irregular side edges or varying perimeter contours at different heights. Preferably, the gripping jaws or gripping bars of the gripping unit, which are advanceable toward each other, are articulatedly mounted and designed such as to be adjustable within a definable adjustment angle about horizontal pivot angles. In this way, it is possible to have a reliable grip at variably adjustable heights. The arrangement according to the invention can provide a handling device and/or manipulating device comprising a gantry robot, which is movable in the area of the handling station and/or grouping station in two horizontal axes, with a gripping unit, which is adjustable in a vertical axis and/or rotatable about the vertical axis. Alternatively, the arrangement can also provide a handling device and/or manipulating device comprising a parallel kinematic robot, which is movable in the area of the handling station and/or grouping station, with a rotatable gripping unit. Such parallel kinematic robots are generally also referred to as tripods (with three arms) or as quad pods (with four arms), respectively, or also as delta robots. These delta robots or parallel kinematic robots typically have three or more upper arms, which are movable about horizontal pivoting axes, with lower arm pairs respectively hinged thereat, the lower ends of which are brought together in movable linkages at a so-called TCP or tool center point, respectively, with the gripping tool arranged thereat such that the gripping tool can be adjusted spatially as well as in its height nearly arbitrarily and at a very high speed by means of variable, motor-driven adjustment movements of the upper arms within a range of movement given by the dimensions of the arms and the maximum adjustment angle. Provided that the TCP is designed to be rotatable, the gripping tool can additionally rotate or pivot in the desired manner. As a further alternative, the handling device and/or manipulating device can additionally comprise a multi-axis robot, which is movable and pivotable about a plurality of axes, with a spatially adjustable and/or rotatable gripping unit.

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged in relation to other elements to facilitate an understanding of the invention.

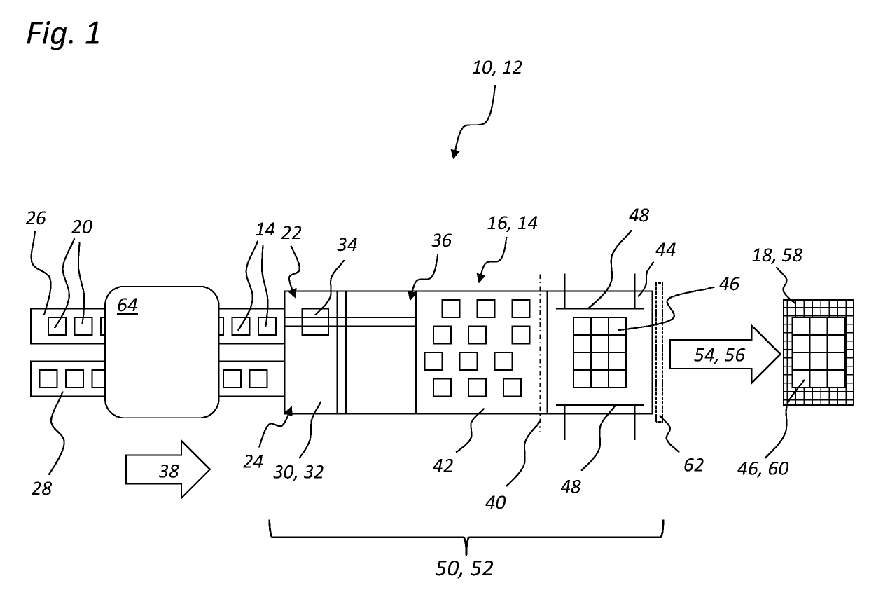

FIG. 1 shows a schematic view of a simple variant of a transport route, in which layers are formed from consecutively transported articles, and then the article layers are subsequently palletized at a stacking station.

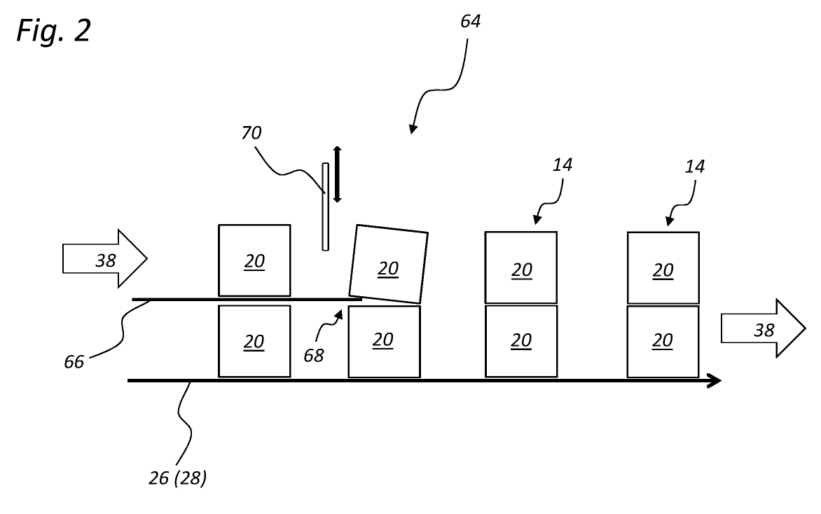

FIG. 2 shows a schematic lateral view of an embodiment variant of a stacking station, which is a part of a feeding section in the transport route according to FIG. 1.

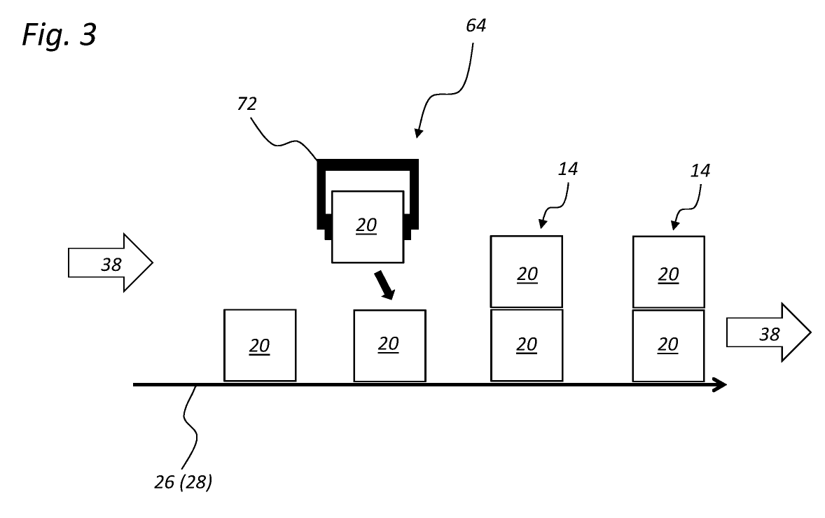

FIG. 3 shows a schematic lateral view of a second embodiment variant of the stacking station according to FIG. 1.

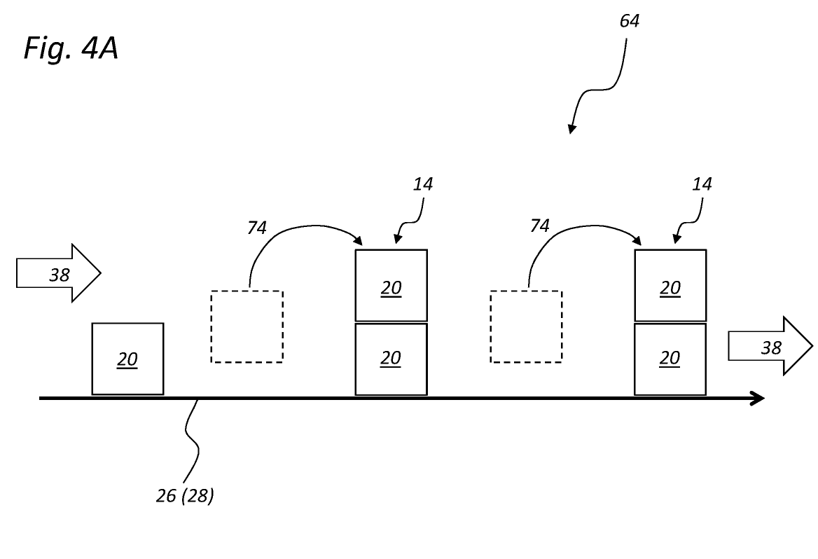

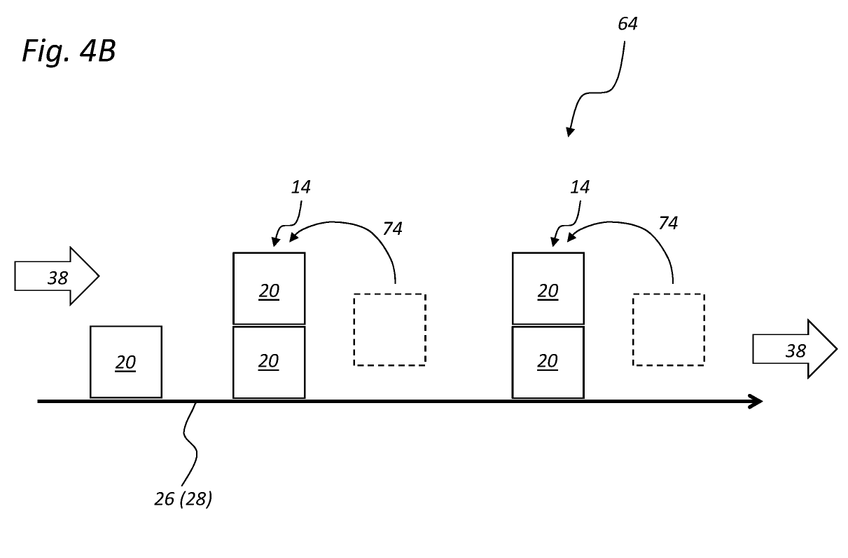

FIG. 4A and FIG. 4B show reasonable stacking devices in two schematic lateral views of a third embodiment variant of the stacking station according to FIG. 1.

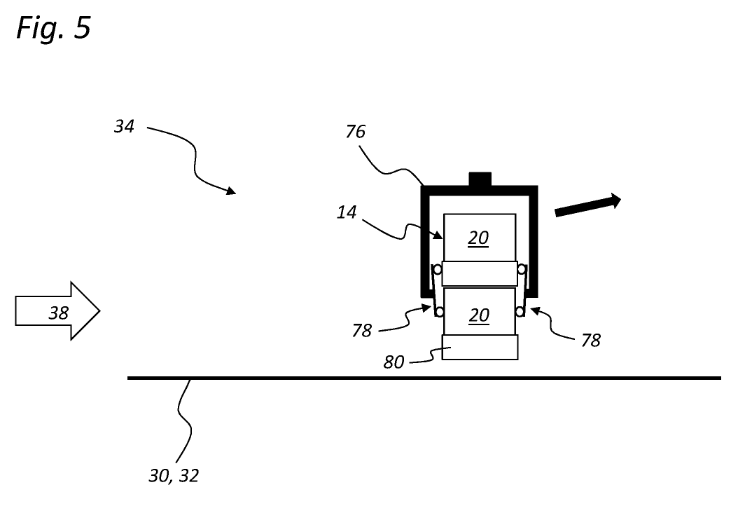

FIG. 5 shows a schematic illustration of an embodiment variant of a handling device and/or manipulating device, which is part of the stacking station according to FIG. 1.

Identical reference characters designate the same or equivalent elements of the invention. Furthermore and for the sake of clarity, only the reference characters relevant for describing the respective figure are provided. It should be understood that the detailed description and specific examples of the device or of the method according to the invention are intended for purposes of illustration only and are not intended to limit the scope of the invention.

The top view of FIG. 1 shows in a very schematic manner a simple variant of a transport route 10 of a station 12 for conveying, handling, and palletizing according to the invention, in which layer forming is to be carried out with article pairs 14 being transported consecutively in a plurality of rows. After passing through the transport route 10, the layers 16 formed from the article pairs 14 are palletized at a stacking station 18, which process is to be explained in more detail hereafter. The article pairs 14, which are only schematically indicated in the illustration in FIG. 1, each consist of two articles 20 of the same size stacked approximately aligned on top of each other, which articles 20 pass through the transport route 10 in this arrangement, and they are treated, manipulated, grouped, and brought into the regular arrangement required for palletizing or stacking, respectively, in each case together in this arrangement. Normally, the two articles 20 of a stacked article pair 14 are only loosely placed one on top of the other; optionally, however, they can also be fixed slightly adhesively to one another, for example, by applying a glue dot or an adhesive surface at the contact surface between the base surface of the top article 20 and the top side of the article 20 located beneath it.

If “articles 20” are referred to in the present context of describing the exemplary embodiment, this is intended to comprise all types of conveyable, manipulatable, groupable, stackable, and/or palletizable packages, piece goods, bundles, or other objects. The term “articles 20” used in a general sense here is therefore to be understood in a comprehensive manner and likewise includes the mentioned conveyable, manipulatable, groupable, stackable, and/or palletizable packages, piece goods, or bundles. If, moreover, “article pairs 14” are almost exclusively referred to in the present context of describing the exemplary embodiment of the invention, this is by no means intended to be understood in a restrictive sense, but rather, by way of deviating from the literal meaning of the word “pair”, to also cover triple stacks of conveyable, manipulatable, groupable, stackable, and/or palletizable articles 20, packages, piece goods, bundles, or other objects, which can optionally be stacked respectively on top of one another not only pairwise, but also triple-wise. It should therefore be explicitly emphasized here that the term “article pair 14” in the present context—by way of deviating from the strict literal meaning of the term “pair”—is to be understood in a comprehensive manner, for it likewise includes the mentioned conveyable, manipulatable, groupable, stackable, and/or palletizable triple stacks of articles 20, packages, piece goods, or bundles.

The transport route 10 of the schematically shown station 12 for conveying, handling, and palletizing in the exemplary embodiment shown in the FIG. 1 comprises two parallel transport tracks 26 and 28, generally referred to as feed stations 22 or 24, respectively, on which in a normal state respectively uninterrupted rows of article pairs 14, each of two articles 20 stacked on top of one another, are conveyed to a grouping table 32, generally referred to as layer forming station 30, and are transferred to it in the area of the feed stations 22 and 24. The grouping table 32 comprises a handling device and/or manipulating device 34 for taking up, rotating, and/or shifting the article pairs 14 having been conveyed onto the grouping table 32 and for forming a loose double layer 16 from the article pairs 14 (or, in the case of triple-wise stacked articles, a triple layer, respectively). The space or the spatial area within which the handling device and/or manipulating device 34 can take over an article pair 14 staged there and shift and/or rotate it is referred to as upper or first feed station 22. In the shown exemplary embodiment, the upper or first feed station 22 is formed by the upper transport track 26 or supplied by it, respectively, with article pairs 14. The space or the spatial area within which the handling device and/or manipulating device 34 can take over an article pair 14 staged there and shift and/or rotate it is referred to as lower or second feed station 24. In the shown exemplary embodiment, the lower or second feed station 24 is formed by the lower transport track 28 or supplied by it, respectively, with article pairs 14. The area where the handling device and/or manipulating device 34 releases the article pairs 14 in the desired position required for producing the specified layer pattern 16 is generally referred to as release position 36.

The loose double layer 16, which is formed by means of the handling device and/or manipulating device 34 by shifting and/or rotating the article pairs 14—after having been assembled by means of the handling device and/or manipulating device 34 and after having passed through the release position 36—is first pushed in conveying direction 38 against a stop device 40, which can be formed, for example, by a vertically liftable and lowerable stopper plate, which can be lifted upward above the level of the grouping table 32 or of the layer forming station 30 for the purpose of pushing together the double layer 16, and which, for the further transport of the double layer 16 having been pushed together without gaps in conveying direction 38, can be lowered back down, i.e. to a level below the conveying plane on which the article pairs 14 and the double layer 16 move in conveying direction 38. Afterward, this double layer 16 of article pairs 14 is conveyed by means of a suitable horizontal conveying device 42 toward the right to a layer forming table 44, on which a compact double layer 46 is formed from the article pairs 14 by pushing together the article pairs 14 of the loose double layer 16 transversely to the conveying direction 38. For the mentioned purpose of pushing together, the layer forming table 44 has suitable pusher devices 48 on both sides of the transport route 10, which are advanceable in a direction in perpendicular to the conveying direction 38 of the double layers 16 or 46, respectively, in order to be able to push the article pairs 14 of the loose double layer 16 against each other as required until the compact double layer 46 according to FIG. 1 has been produced, which has largely no more longitudinal or transversal gaps left between the article pairs 14 that stand against each other.

It should be noted here that the mentioned horizontal conveying device 42, which is located at least between the layer forming station 30 or the grouping table 32, respectively, and the layer forming table 44, can likewise extend from the layer forming station 30 with the associated handling device and/or manipulating device 34 to the layer forming table 44, since the article pairs 14, the loose double layer 16, as well as the compact double layer 46 are conveyed in conveying direction 38 to the stacking station 18 preferably continuously.

The grouping table 32, which represents the layer forming station 30, the horizontal conveying device 42 arranged following it or downstream in conveying direction 38 therefrom, respectively, with the stop device 40, as well as the layer forming table 44 arranged following it or downstream in conveying direction 38, respectively, from this horizontal conveying device 42 with the laterally advanceable pusher devices 48 together form the manipulating section 50 in the sense of the present invention, since the manipulating section 50 comprises both the handling station as well as the grouping station 52, with a palletizing station 54 being arranged downstream in conveying direction 38 from the manipulating section 50 for stacking and/or palletizing the stackable or palletizable article pairs 14 having been assembled in the grouping station 52 to double layers 16 or 46, respectively.

In the context of the present invention, any device is regarded as handling device and/or manipulating device 34, which is able and suitable for shifting into a desired direction and/or for rotating about their vertical axis (or axes) the article pairs 14, package pairs, piece good pairs, and/or bundle pairs, which have been transferred from the transport tracks 26 and 28 or from the feed stations 22 and 24, respectively, to the grouping table 32 or to the layer forming station 30, for the purpose of producing a desired layer pattern 16. As mentioned above, this layer pattern 16 is subsequently compacted by way of pushing against the stop device 40 as well as by pushing laterally against each other by means of the pusher devices 48 in order to reduce the gaps between the article pairs 14, which have been pushed together to the desired compact layer pattern 46. This process can be carried out, for example, in the area of the layer forming table 44, which is arranged downstream from the grouping table 32 with the therewith associated handling device and/or manipulating device 34.

After the palletizable double layer 46 has been formed on the layer forming table 44, the compact double layer 46 is deposited, as the case may be, by way of stacking it as a complete double layer 46 on the stacking station 18 on top of palletized double layers 46 already laying there by means of a suitable transfer device and/or transport device 56, which is only indicated here by the reference character and an arrow, and which is part of the palletizing station 54. The bottommost layer 46 can be, in particular, deposited on a pallet 58 or the like. As soon as a defined maximum number of layers 46 has been deposited on top of each other on the pallet 58, the thus formed complete layer stack 60 can be transported away for further packaging and/or for shipment or storage. As required, a transfer slide device 62, such as, for instance, a foldable transfer slide panel or the like, which supports the transfer to a transport device, can be arranged between the layer forming table 44 and the transfer device and/or transport device 56.

In contrast to the shown arrangement, the manipulating section 50, which is only schematically indicated in FIG. 1, can also have more than the shown modules arranged respectively consecutively one after the other. For example, two grouping tables 32 or layer forming stations 30 of the same type can thus be arranged immediately one after another in order to increase the processing velocity in the area of the transport route 10. Likewise, a transfer section or the like can be arranged downstream from the layer forming table 44, where the transfer section is equipped with a gripper, such as, for example, a shutter-type gripper head, which can take over complete double layers 46 and spatially displace them in order to stack them on top of one another on the stacking station 18 and to palletize them there to form a layer stack 60.

Furthermore, the station 12 for conveying, handling, and palletizing shown in FIG. 1 comprises a stacking station 64 arranged upstream in conveying direction 38 from the handling station and/or grouping station 52 for the purpose of pairwise or triple-wise stacking on top of one another the articles 20 being sequentially supplied on the transport tracks 26 and 28 and for the purpose of forming the article pairs 14 or the triple stacks of articles 20 before they are transferred to the handling station and/or grouping station 52. In the exemplary embodiment shown here, the stacking station 64 is arranged in the area of the two parallel transport tracks 26 and 28, which are generally referred to as feed stations 22 or 24, respectively, on which respectively uninterrupted rows of articles 20 are first conveyed to the stacking station 64, there stacked on top of one another pairwise or triple-wise, and subsequently conveyed in each case as two (or optionally three) articles 20 stacked on top of one another, i.e. as article pairs 14, to the layer forming station 30 or the grouping table 32 and transferred to it in the area of the feed stations 22 and 24. As is discernible in outlines in FIG. 1, the stacking station 64 is arranged immediately upstream in conveying direction 38 from the handling station and grouping station 52. The stacking station 64 can be combined with the handling station and/or grouping station 52, for example, in an integrated design or in a so-called block design.

The FIG. 2 shows a schematic lateral view of an embodiment variant of the stacking station 64, which is a part of the feeding section in the transport route 10 according to FIG. 1. According to FIG. 1, the stacking station 64 is located in the area of the parallel transport tracks 26 or 28, respectively, which are generally referred to as feed stations 22 or 24, respectively, on which articles 20 are conveyed, respectively regularly spaced apart, in conveying direction 38. Only one of the two transport tracks, in this instance the upper or left transport track 26, respectively, is discernible in the schematic lateral view of FIG. 2. The same arrangement, however, is also located in an identical form on the lower or right transport track 28, respectively (cf. FIG. 1 in this context). Located immediately above the transport track 26 is a complementary upper transport track 66, on which articles 20 are likewise conveyed regularly spaced apart in conveying direction 38. In the area of the end of the upper transport track 66, a conveyor track switch 68 is formed by means of which articles 20 being conveyed above one another are stacked to form article pairs 14. The conveyor track switch 68 can be formed as shown here by transport tracks 26 and 66 running precisely parallel and being precisely aligned in transport direction 38. Optionally, the conveyor track switch 68 can also be formed by transport tracks 26 and 66 running diagonally toward each other, where the upper transport track 66, for example, is inclined in conveying direction 38 diagonally downward toward the lower transport track 26. Optionally, the transport tracks 26 and 66 can also lead laterally toward one another; this, however, cannot be illustrated in the drawing of FIG. 2.

In order to form even article pairs 14 at the end of the complementary upper transport track 66, which ends in the area of the stacking station 64, in which article pairs 14 the articles 20 stacked on top of one another are respectively precisely aligned with each other, it is important that the positions of the articles 20 being conveyed in conveying direction 38 above one another on the lower transport track 26 and on the upper transport track 66 are aligned as precisely as possible with each other. On the one hand, it is reasonable to synchronize the conveying velocities of the two transport tracks 26 and 66 arranged above one another so as to achieve this precise alignment. On the other hand, it can moreover be reasonable, as the case may be, to briefly decelerate the articles 20 on the upper transport track 66, as required, by means of suitable retaining devices 70, formed, for example, by a vertically movable retaining bar according to FIG. 2, or to briefly accelerate them, respectively, for example, by way of short-term acceleration of the upper transport track 66 in order to produce the desired alignment of the upper and lower articles 20 on the tracks 26 and 66 in this manner.

As is discernible from FIG. 2, the articles 20 are stacked on top of one another at the conveyor track switch 68 at the end of the upper transport track 66 by the articles 20 on the upper track 66 being deposited on the respective top sides of the articles 20 of the lower track 26. The article pairs 14 formed in such a manner are conveyed further along without delay or interruption on the transport track 26 and, at the feed station 22, are conveyed onto the grouping table 32 serving as layer forming station 30, where the complete article pairs 14 can subsequently be taken up, shifted, and/or rotated by means of the handling device and/or manipulating device 34, as previously described by means of FIG. 1.

The FIG. 3 shows a schematic lateral view of a second embodiment variant of the stacking station 64, which is a part of the feeding section in the transport route 10 according to FIG. 1. The stacking station 64 is again located in the area of the parallel transport tracks 26 or 28, respectively, which are generally referred to as feed stations 22 or 24, respectively, on which articles 20 are conveyed, respectively regularly spaced apart, in conveying direction 38. Only one of the two transport tracks, in this instance the upper or left transport track 26, respectively, is discernible in the schematic lateral view of FIG. 3. The same arrangement, however, is also located in an identical form on the lower or right transport track 28, respectively (cf. FIG. 1 in this context).

The stacking station 64 shown in FIG. 3 provides to stack the articles 20 for the purpose of forming the article pairs 14 by means of separate gripping devices 72, which remove individual articles 20 from a supply track not shown here and place them on each top side of the articles 20 being conveyed on the transport track 26. The gripping device 72, which is only schematically indicated here, can be part of a handling robot, for example, which is formed by a robot that is spatially movable in multiple axes, for example, or also by a gantry robot or the like.

Other variants than those shown in FIG. 2 and FIG. 3 are moreover conceivable for the stacking station 64. The FIG. 4 thus shows such a further variant of the stacking station 64, in which the articles 20 being conveyed on the transport tracks 26 and 28 are respectively stacked on top of one another by means of a gripping device 72. The FIGS. 4A and 4B again show schematic lateral views of the upper or left transport tracks 26, respectively. The right or lower transport track 28 (cf. FIG. 1), respectively, is, however, constructed in the same way such that the stacking station 64 comprises both transport tracks 26 and 28 likewise. As is only indicated in FIG. 4A, for instance, every other article 20 can be placed onto the article 20 being conveyed respectively in front of it by means of a movement 74, aligned in conveying direction, of gripping, taking up, and setting down performed by a gripping device 72 (cf. FIG. 3 in this context), in order to form the desired article pairs 14 in this manner. As is illustrated in FIG. 4B, it is likewise conceivable to place every other article 20 onto the article 20 being conveyed respectively behind it by means of a movement 74, aligned in opposite to the conveying direction, of gripping, taking up, and setting down performed by the gripping device 72 (cf. FIG. 3 in this context), in order to form the desired article pairs 14 in this manner.

It is possible to increase the output of existing palletizing facilities in the manner shown without substantially changing the machinery, because the articles 20, which are stacked in the feed section to the layer forming station 30, make it possible for the grouping table 32 to either rotate and/or shift the article pairs 14 at a lower speed or to handle a greater total number per time interval of articles 20 at the same speed, since always two articles 20 of an article pair 14 are moved at the same time. On the whole, combining the articles 20 to pairs 14 (or also to triple stacks of articles, as the case may be) in this way leads to a noticeable output increase of the station 12 for conveying, handling, and palletizing, because approximately double the number of articles 20 than would be possible in the instance of articles 20 that are not combined to pairs 14 can be moved and grouped to the loose double layer 16 in the same time, with basically the same transfer movements and rotary motions of the handling device and/or manipulating device 34 of the grouping station 32.

The schematic illustration of FIG. 5 shows an embodiment variant of the handling device and/or manipulating device 34 that is associated with the grouping table 32 and formed by a gripping unit 76, which is shiftable, rotatable, and/or liftable and lowerable, for example, by means of a gantry robot, with gripping jaws 78 that are advanceable toward each other for seizing and manipulating the groups of articles 20, which are stacked pairwise on top of one another, for the purpose of taking up, rotating, and/or shifting them within the manipulating section of the grouping station 32 (cf. FIG. 1). As is discernible in FIG. 5, the gripping jaws 78 of the gripping unit 76, which gripping jaws 78 are advanceable toward each other, are respectively variably adaptable to different contours of the lateral surfaces of the article pairs 14 to be seized. Such an adaptable gripper 76 serves for securely seizing the double or triple stacks, in particular if these have irregular side edges or varying perimeter contours in different heights, as is discernible in outlines in FIG. 5.

Preferably, the gripping jaws 78 of the gripping unit 76, which gripping jaws 78 are advanceable toward each other, are articulatedly mounted and designed such as to be adjustable within a definable adjustment angle about horizontal pivot angles. In this way it is possible to reliably grip the article pairs 14 at variably adjustable heights. Since the articles 20 of an article pair 14 are typically only loosely stacked on top of one another, the gripping jaws 78 serve for reliably seizing both articles 20, even if their side walls are broadened irregularly or in the lower section and in the base section, respectively, by a lower reception tray 80, for example, such as a cardboard shell or plastic shell, as is indicated for both articles 20 in FIG. 5. In this instance, a plurality of individual piece goods of the same size and type are typically assembled in the reception tray 80 such that the article 20 would typically be referred to as a bundle of piece goods or articles, respectively, that are assembled and held together.

According to FIG. 5, the handling device and/or manipulating device 34 can optionally comprise a gantry robot, which is movable in the area of the handling station and/or grouping station 52 (cf. FIG. 1) in two horizontal axes, with a gripping unit 76, which is adjustable in a vertical axis and/or rotatable about the vertical axis. It is likewise conceivable that the handling device and/or manipulating device 34 comprises a parallel kinematic robot, which is movable in the area of the handling station and/or grouping station 52, with a rotatable gripping unit 76. Moreover, it is conceivable for the handling device and/or manipulating device 34 to comprise a multi-axis robot, which is movable and pivotable about a plurality of axes, with a spatially adjustable and/or rotatable gripping unit 76.

The invention has been described with reference to a preferred embodiment. Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

### LIST OF REFERENCE CHARACTERS

10 Transport route
12 Station for conveying, handling, and palletizing
14 Article pairs
16 Article layers, layer pairs, double layers, loose double layer (of article pairs), layer pattern
18 Stacking station
20 Article
22 First feed station, left feed station, upper feed station
24 Second feed station, right feed station, lower feed station
26 First transport track, left transport track, upper transport track
28 Second transport track, right transport track, lower transport track
30 Layer forming station
32 Grouping table
34 Handling device and/or manipulating device
36 Release position
38 Conveying direction
40 Stop device
42 Horizontal conveying device
44 Layer forming table
46 Compact double layer, double layer that is pushed together
48 Pusher devices, transverse pusher devices
50 Manipulating section
52 Handling station and/or grouping station
54 Palletizing station
56 Transfer device and/or transport device
58 Pallet
60 Layer stack
62 Transfer slide device, transfer slide panel
64 Stacking station
66 Complementary transport track, upper transport track
68 Conveyor track switch
70 Retaining device
72 Gripping device
74 Gripping movement, take up and set down movement, stacking movement
76 Gripper, gripping unit
78 Gripping jaws
80 Reception tray

1. A method for conveying, handling, manipulating, stacking, and/or palletizing articles (20), piece goods, and/or bundles, which are fed in conveying direction (38) to a handling station and/or grouping station (52) and are taken up there within a defined manipulating section (50) by means of a handling device and/or manipulating device (34), are rotated and/or shifted and thus respectively brought into an arrangement (46) to each other so as to be stackable or palletizable, which arrangements (46) can subsequently be stacked on top of one another and/or palletized for the purpose of forming stacked layers (60) of articles, piece goods, and/or bundles, wherein the stacked groups (14) of articles, piece goods, and/or bundles, which are transferred to the handling station and/or grouping station (52), are double- or triple-stacked on top of one another in a stacking section (64), which is arranged upstream, in particular, spatially immediately upstream in conveying direction (38), from the handling station and/or grouping station (52), and wherein the articles (20), piece goods, and/or bundles are transferred to the handling station and/or grouping station (52) as pairs or triplets (14), which have been stacked pairwise or triple-wise on top of one another.

2. The method as recited in claim 1, in which the stacked groups (14) of articles, piece goods, and/or bundles are stacked by means of conveyor track switches (68), which release individual articles (20), piece goods, and/or bundles at respectively different heights and thus stack them on top of one another.

3. The method as recited in claim 1, in which the stacked groups (14) of articles, piece goods, and/or bundles are stacked by means of separate gripping devices (72), which are arranged upstream from the handling station and/or grouping station (52), which gripping devices (72) take up individual articles (20), piece goods, and/or bundles from the horizontal conveying devices or feeder devices and place them on top of respectively other articles (20), piece goods, and/or bundles and thus stack them on top of one another.

4. The method as recited in one of the claims 1 to 3, in which the handling device and/or manipulating device (34) of the handling station and/or grouping station (52) seizes the groups (14) of articles, piece goods, and/or bundles, which are stacked pairwise or triple-wise on top of one another, at variably adjustable heights for the purpose of taking up, rotating, and/or shifting them within the manipulating section (50).

5. An arrangement of stations (12) for conveying, handling, and/or palletizing, which are arranged consecutively in conveying direction (38), for the purpose of conveying, handling, manipulating, stacking, and/or palletizing articles (20), piece goods, and/or bundles, with:
a handling station and/or grouping station (52), which comprises a handling device and/or manipulating device (34) for taking up, rotating, and/or shifting the articles (20), piece goods, and/or bundles within a defined manipulating section (50);
with a palletizing station (54) arranged downstream in conveying direction (38) from the handling station and/or grouping station (52) for the purpose of stacking and/or palletizing stackable or palletizable arrangements (46) of articles, piece goods, and/or bundles,
and with a stacking station (64) arranged upstream in conveying direction (38) from the handling station and/or grouping station (52) for the purpose of pairwise or triple-wise stacking on top of one another articles (20), piece goods, and/or bundles before they are transferred to the handling station and/or grouping station (52).

6. The arrangement as recited in claim 5, in which the stacking station (64) is arranged upstream, in particular, spatially immediately upstream in conveying direction (38), from the handling station and/or grouping station (52).

7. The arrangement as recited in claim 5 or 6, in which the stacking station (64) comprises conveying devices (66) with conveyor track switches (68) for transferring individual articles (20), piece goods, and/or bundles at respectively different heights and for stacking them on top of one another.

8. The arrangement as recited in claim 5 or 6, in which the stacking station (64) comprises separate gripping devices (72) for taking up individual articles (20), piece goods, and/or bundles from horizontal conveying devices or feeder devices and for placing them on respectively other articles (20), piece goods, and/or bundles.

9. The arrangement as recited in one of the claims 5 to 8, in which a handling device and/or manipulating device (34) of the handling station and/or grouping station (52) comprises a shiftable, rotatable, and/or liftable and lowerable gripping unit (76) with gripping jaws (78) or gripping bars, which are advanceable toward each other, for seizing and manipulating the groups (14) of articles, piece goods, and/or bundles, which are stacked pairwise or triple-wise on top of one another, for the purpose of taking up, rotating, and/or shifting them within the manipulating section (50), wherein the gripping jaws (78) or gripping bars of the gripping unit (76), which gripping jaws (78) are advanceable toward each other, are respectively variably adaptable to different contours of the lateral surfaces of the groups (14) of articles, piece goods, and/or bundles to be seized.

10. The arrangement as recited in claim 9, in which the gripping jaws (78) or gripping bars of the gripping unit (76), which gripping jaws (78) are advanceable toward each other, are articulatedly mounted and adjustable within a definable adjustment angle about horizontal pivot angles.

11. The arrangement as recited in one of the claims 5 to 10, in which the handling device and/or manipulating device (34) comprises a gantry robot, which is movable in the area of the handling station and/or grouping station (52) in two horizontal axes, with a gripping unit (76), which is adjustable in a vertical axis and/or rotatable about the vertical axis.

12. The arrangement as recited in one of the claims 5 to 10, in which the handling device and/or manipulating device (34) comprises a parallel kinematic robot, which is movable in the area of the handling station and/or grouping station (52), with a rotatable gripping unit (76).

13. The arrangement as recited in one of the claims 5 to 10, in which the handling device and/or manipulating device (34) comprises a multi-axis robot, which is movable and pivotable about a plurality of axes, with a spatially adjustable and/or rotatable gripping unit (76).
